(19) United States
(12) Patent Application Publication
(10) Pub. No.: US 2004/0193522 A1
(43) Pub. Date: Sep. 30, 2004

(54) Check verification, check cashing and check settlement interface

(76) Inventors: Todd Michael Binet, Houston, TX (US); Kenneth E. Rees, Dallas, TX (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/755,404

(22) Filed: Jan. 13, 2004

Related U.S. Application Data
(63) Continuation-in-part of application No. 10/200,690, filed on Jul. 22, 2002.
(60) Provisional application No. 60/307,655, filed on Jul. 26, 2001.

(51) Int. Cl. G06F 17/60

(52) U.S. Cl. 705/35

(57) ABSTRACT

A method, a framework, and a computer program product for an interface for providing check verification, cashing and electronic settlement services are provided. The method receives information including check information for a check being negotiated for monies. The check information is verified by comparing the received check information with issued check information stored at the check issuing financial institution. Upon verifying the received check information, a status flag associated with the check information is modified to indicate that the received check information has been verified and the system marks a void or presentment notification with the check. The verified check information representing an issued check is then authorized for cash settlement. Upon exchanging the check for monies, information is transmitted to the financial institution notifying the financial institution that the check has been negotiated and the issuing financial institution submits a settlement file in the amount of the settled amount to a designated account.

### CROSS-REFERENCE TO RELATED APPLICATIONS

This application is a continuation-in-part of U.S. patent application Ser. No. 10/200,690, filed Jul. 22, 2002, now pending, and also claims priority to U.S. Patent Provisional Application No. 60/307,655, filed Jul. 26, 2001. The entire disclosures of these applications are incorporated by reference herein.

### BACKGROUND OF THE INVENTION

1. Field of the Invention

The present invention relates to a method, a system and computer program product for providing check verification, authentication, check cashing and electronic settlement services. More particularly, the present invention relates to a method, a system and a computer program product for an interface for providing check verification, check cashing and electronic settlement services.

2. Description of the Prior Art

The distribution, negotiation and settlement of checks are common transactions for today's financial institutions. For example, and not by way of limitation, tax refund anticipation loans have become a common transaction that occurs during tax season. Typically, tax refund anticipation loans are offered to individuals whose tax returns indicate that they are owed a refund from the federal or a state government. An individual interested in receiving a tax refund anticipation loan is merely required to inform his tax preparer that he wishes to execute a tax anticipation loan application. The executed application is forwarded by the tax preparer to a financial institution. Upon approval of a tax refund anticipation loan application, the tax preparer arranges for the issuing of a check in the amount of the individual's anticipated refund less any appropriate fees. Once the check is issued, it is given to the individual.

One problem with receiving a check is negotiating the check in exchange for monies. Financial institutions are not required to honor another finance institution's checks. Accordingly, an individual with a check has to either find a location of the financial institution that issued the check or another financial institution that is willing to honor the check. This process can be a time consuming and frustrating experience when financial institutions have limited locations coupled with long bank teller lines.

Another problem is that even when an individual does find a financial institution willing to honor a check, the financial institution may require that it be deposited and the individual wait several days for the check to clear before they can actually receive monies. This delay is caused by the check having to go to the federal reserve, and to the financial institution that issued the check for presentment of that check, assuming the check is authentic and for the correct amount. This delay can defeat one of the purposes of a check such as when the individual needs the funds to satisfy an immediate financial need.

Thus, there is a need for i) check cashing services, ii) the method to negotiate and settle a check disbursed by a financial institution, iii) the method to negotiate and settle a check at a location issuing the check, such as a tax preparation site, and iv) the method to immediately provide the check recipient with monies in exchange for negotiating the check. In addition, there is a need for the method to verify and authenticate the check to prevent fraudulent negotiation of the check and a need for the method to settle the check after it has been honored.

### SUMMARY OF THE INVENTION

According to embodiments of the present invention, a method, a framework, and a computer program product for an interface for providing check verification, cashing and electronic settlement services are provided. The method receives information including check information for a check being negotiated for monies. The check information is verified by comparing the received check information with issued check information stored at the check issuing financial institution. Upon verifying the received check information, a status flag associated with the check information is modified to indicate that the received check information has been verified and the system marks a void or presentment notification with the check. The verified check information representing an issued check is then authorized for cash settlement. Upon exchanging the check for monies information is transmitted to the financial institution notifying the financial institution that the check has been negotiated and the issuing financial institution submits a settlement file in the amount of the settled amount to a designated account. The present invention allows one to cash a check safely and securely through the electronic presentment of the check to the issuing financial institution. By presenting the check to the issuing financial institution, one can verify its authenticity and generate a settlement in favor of the entity providing the monies for the check.

### BRIEF DESCRIPTION OF THE DRAWINGS

The above described features and advantages of the present invention will be more fully appreciated with reference to the detailed description and appended figures in which:

FIG. 1 depicts an exemplary block diagram of a system which can find application according to an embodiment of the present invention;

FIG. 2 depicts an exemplary block diagram of a system of FIG. 1 which can find application according to an embodiment of the present invention;

FIG. 3 depicts an exemplary block diagram of a system of FIG. 1 which can find application according to an embodiment of the present invention;

FIG. 4 depicts an exemplary block diagram of a system of FIG. 1 which can find application according to an embodiment of the present invention;

FIG. 5 depicts an exemplary block diagram of a system of FIG. 1 which can find application according to an embodiment of the present invention;

FIGS. 6A-6B depict an exemplary flow diagram of a method of providing an interface for verifying checks according to an embodiment of the present invention; and

FIGS. 7A-7B depict an exemplary flow diagram of a method of providing an interface for electronic settlement of a check cashing transaction according to an embodiment of the present invention.

### DETAILED DESCRIPTION OF THE INVENTION

The present invention is now described more fully hereinafter with reference to the accompanying drawings that show exemplary embodiments of the present invention. The present invention, however, can be embodied in many different forms and should not be construed as limited to the exemplary embodiments set forth herein. Appropriately, these embodiments are provided so that this disclosure will be thorough, complete, and fully convey the scope of the present invention.

According to embodiments of the present invention, a method, a framework, and a computer program product for an interface for providing check verification, cashing and electronic settlement services are provided. The method receives information including check information for a check being negotiated for monies. The check information is verified by comparing the received check information with issued check information stored at the check issuing financial institution. Upon verifying the received check information, a status flag associated with the check information is modified to indicate that the received check information has been verified and the system marks a void or presentment notification with the check. The verified check information representing an issued check is then authorized for cash settlement. Upon exchanging the check for monies information is transmitted to the financial institution notifying the financial institution that the check has been negotiated and the issuing financial institution submits a settlement file in the amount of the settled amount to a designated account. The present invention allows one to cash a check safely and securely through the electronic presentment of the check to the issuing financial institution. By presenting the check to the issuing financial institution, one can verify its authenticity and generate a settlement in favor of the entity providing the monies for the check.

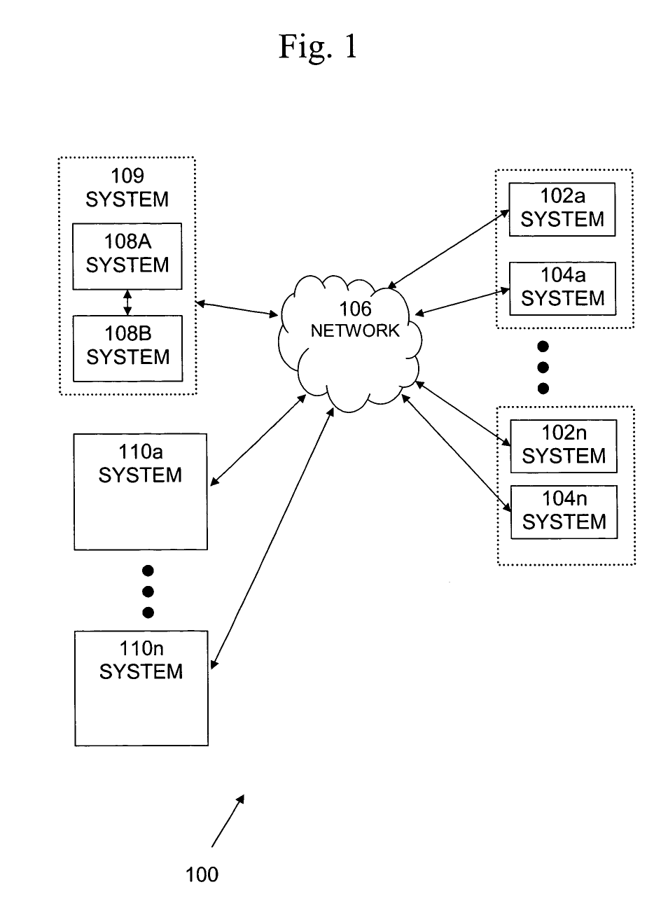

An exemplary block diagram of a system in which the present invention can find application according to an embodiment of the present invention is shown in FIG. 1. In the embodiment of FIG. 1, system 100 can be implemented to provide an interface for check cashing, check verification and check settlement at a device including, but not limited to, an ATM and cash register. In the FIG. 1 embodiment of the present invention, system 100 includes systems 102a-102n, systems 104a-104n, network 106, system 109 and systems 110a-1110n. The system 100 can transmit, using the network 106, any combination of voice, video and/or data between systems 102a-102n, systems 104a-104n, system 109 and systems 110a-110n.

In the FIG. 1 embodiment of the present invention, each of the systems 102a-102 b is coupled to systems 104a- 104n, system 109 and systems 110a- 110n via network 106. Each of the systems 102 can be provided at respective locations, where each system 102 is coupled to network 106. Each system 102 can be any apparatus from which, and to which, any combination of voice video and/or data can be transmitted over a network 106, such as the Internet. In the FIG. 1 embodiment of the present invention, each of the systems 102 is a Point of Sale (POS) terminal that includes, but is not limited to, a display, input/output device such as a scanner, a bar code reader, a biometric scanner, a keypad and a receipt printer. Each of the systems 102 can receive check information, customer identification information, and clerk identification information, transmit check cashing transaction information, and receive status notification information employing network 106, generate receipts having a check authorization code imprinted thereon, and marking checks with void or presentment notifications. Each of the systems 102 can be provided at a site where checks are offered including, but not limited to, a tax preparation site.

In the FIG. 1 embodiment of the present invention, each of the systems 104 is coupled to system 109 and systems 110a-110n via network 106. Each system 104 can be provided at respective locations, where each system 104 is coupled to network 106. Each of the systems 104 can be any apparatus from which, and to which, any combination of voice, video and/or data can be transmitted over a network 106, such as the Internet. In the FIG. 1 embodiment of the present invention, each of the systems 104 is an ATM that includes, but is not limited to, a display, an input/output device, such as a keypad, a receipt printer and a cash dispenser. Each of the systems 104 can receive customer identification information, check authorization codes and cash disbursement notifications and transmit disbursement requests including, but not limited to, the customer identification information and the check authorization code employing network 106, and dispense monies. The present invention contemplates that a respective system 104 may be provided in the same physical location as a respective system 102 or separate physical locations from systems 102.

In the FIG. 1 embodiment of the present invention, a system 109 is coupled to systems 110a-110n via network 106. The network 106 can include one of a Virtual Private Network (VPN) and Frame circuit to provide a direct link between system 108 and a respective system 110. System 109 and each of the systems 110 communicate employing an Active Server Page (ASP) model. Each of the systems 109 can be any apparatus from which, and to which, any combination of voice, video and/or data can be transmitted over a network 106, such as the Internet. In the FIG. 1 embodiment of the present invention, each of the systems 109 includes, but is not limited to, a settlement system 108A and a verification system 108B. The system 108A can receive notification, and provide confirmation, that monies have been dispensed in connection with a check. The verification system 108B can verify a check and provide confirmation that the check has been verified. In the FIG. 1 embodiment of the present invention, the system 108A and the system 108B are logically or physically connected to system 109.

In the FIG. 1 embodiment of the present invention, system 109 can receive information requests and responses as well as transmit notification requests and responses. The system 108B can receive check cashing transaction information, verification responses, including, but not limited to, the verification request, a verification code, time data and date data, process the check cashing transaction information and verification responses, and transmit verification responses and status notifications. The system 108A can receive disbursement requests, process disbursement requests, transmit funds disbursement notifications and settlement notifications employing network 106.

In the FIG. 1 embodiment of the present invention, each of the systems 110 is coupled to network 106. A system 110 can be provided at various locations, where each system 110 is coupled to network 106. Each of the systems 110 can be any apparatus from which, and to which, any combination of voice, video and/or data can be transmitted over a network 106, such as the Internet. In the FIG. 1 embodiment of the present invention, each of the systems 110 can receive verification requests and settlement notifications, process verification requests, including but not limited to, verifying a segment of transaction information as provided by system 109. In the FIG. 1 embodiment of the present inventory, each of the system 110 can flag the segment of the transaction information as verified, transmit a verification response, and create a settlement file. Each of the systems 110 can be provided at a respective location of a check issuing financial institution. The network 106 can be any communications medium over which any combination of voice video and/or data can be transmitted, such as a Wide Area Network (WAN), Local Area Network (LAN) and Internet.

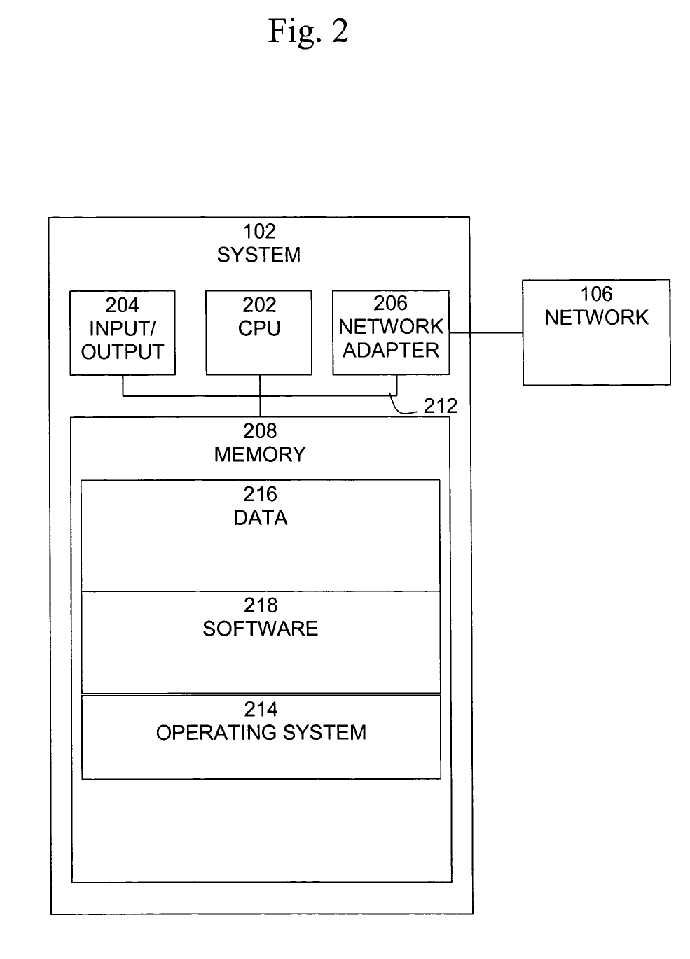

An exemplary block diagram of a system 102 of FIG. 1 which can find application according to an embodiment of the present invention is shown in FIG. 2. In the FIG. 2 embodiment of the present invention, system 102 includes input/output device interface 204, network adapter 206, system memory 208 and CPU 202. The CPU 202 is connected by a bus 212 or other suitable interface means to system memory 208, input/output device interface, 204 and network adapter 206. The CPU 202 executes program instructions in order to carry out the functions of the present invention.

Input/output device interface 204 provides the capability to input data to, or output data from system 102. For example, input/output device interface 204 includes, but is not limited to, input devices such as a readers, a biometric reader, a keypad, mice, touchpads, trackballs, etc., output devices such as video, monitors, printers, etc., and input/output devices such as dialers/modems, etc. Input/output device interface 204 enables input of check information, customer identification information, and clerk identification information, as well as output of receipts having a check authorization code imprinted thereon and marking of checks with void notification. Network adapter 206 interfaces system 102 with network 106.

System memory 208 stores program instructions that are executed by, and data that are used and processed by, CPU 202 to perform the functions of system 102. System memory 208 can include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which can use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the FIG. 2 embodiment of the present invention, system memory 208 includes operating system 214, data 216 and software 218. Operating system 214 provides overall system functionality. The data 216 can include check information, customer identification information, clerk identification information and check authorization codes. The software 218 provides the functionality for receiving and transmitting information as well as generating receipts and marking checks with void or presentment notifications.

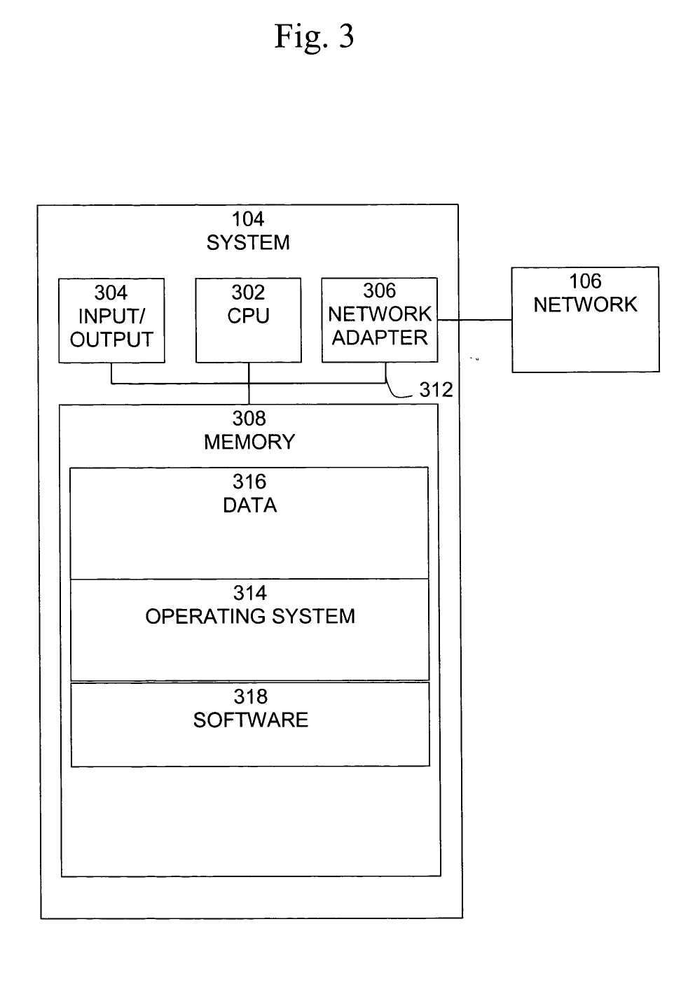

An exemplary block diagram of a system 104 of FIG. 1 which can find application according to an embodiment of the present invention is shown in FIG. 3. In the FIG. 3 embodiment of the present invention, the system 104 includes input/output device interface 304, network adapter 306, system memory 308 and CPU 302. The CPU 302 is connected by a bus 312 or other suitable interface means to system memory 308, input/output device interface 304, and network adapter 306. The CPU 302 executes program instructions in order to carry out the functions of the present invention.

Input/output device interface 304 provides the capability to input data to, or output data from system 104. For example, input/output device interface 304 includes, but is not limited to, input devices such as a card readers, keypads, mice, touchpads, trackballs, etc., output devices such as video, monitors, printers, cash dispenser, etc., and input/output devices such as dialer/modems, etc. Input/output device interface 304 enables input of customer identification information and check authorization codes and dispensing of cash. Network adapter 306 interfaces system 104 with network 106.

System memory 308 stores program instructions that are executed by, and data that are used and processed by, CPU 302 to perform the functions of system 104. System memory 308 can include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which can use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the FIG. 3 embodiment of the present invention, system memory 308 includes operating system 314, data 316 and software 318. Operating system 314 provides overall system functionality. The data 316 can include customer identification information and a check authorization code. The software 318 provides the functionality for receive customer identification information and an check authorization code, transmit a disbursement request including, but not limited to, the customer identification information and the check authorization code employing network 106, receive cash disbursement notification and dispense monies.

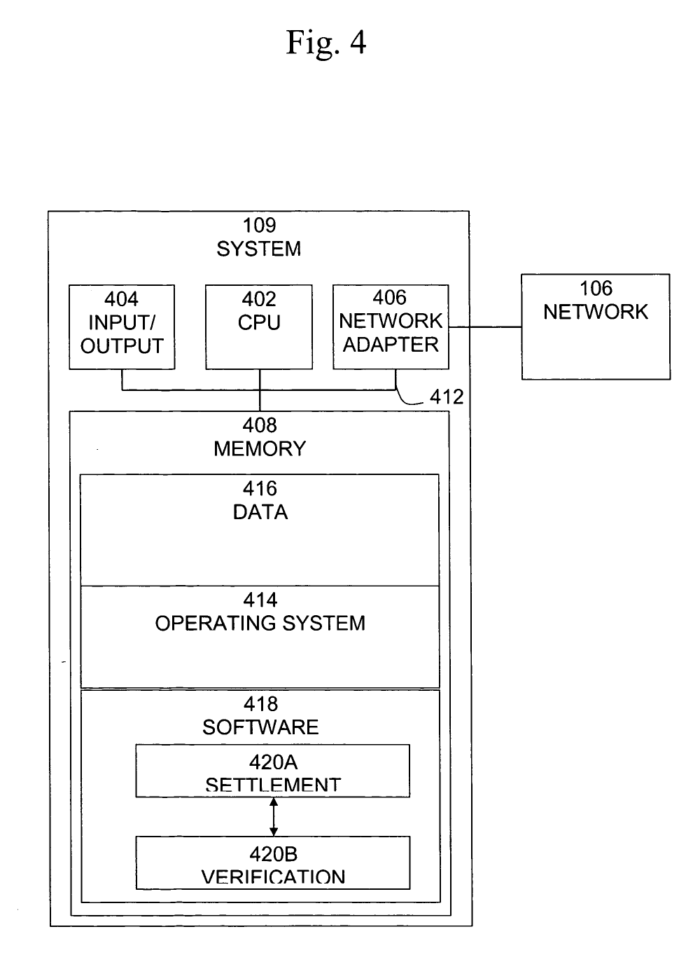

An exemplary block diagram of a system 109 of FIG. 1 which can find application according to an embodiment of the present invention is shown in FIG. 4. In the FIG. 4 embodiment of the present invention, the system 109 includes input/output device interface 404, network adapter 406, system memory 408 and CPU 402. The CPU 402 is connected by a bus 412 or other suitable interface means to system memory 408, input/output device interface 404, and network adapter 406. The CPU 402 executes program instructions in order to carry out the functions of the present invention.

Input/output device interface 404 provides the capability to input data to, or output data from system 109. For example, input/output device interface 404 includes, but is not limited to, input devices such as a readers, keyboards, mice, touchpads, trackballs, etc., output devices such as video, monitors, printers, etc., and input/output devices such as dialer/modems, etc. Input/output device interface 404 enables input of check transaction information, verification requests, verification codes, time data and date data. Network adapter 406 interfaces system 109 with network 106.

System memory 408 stores program instructions that are executed by, and data that are used and processed by, CPU 402 to perform the functions of system 109. System memory 408 can include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which can use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the FIG. 4 embodiment of the present invention, system memory 408 includes operating system 414, data 416 and software 418. Operating system 414 provides overall system functionality. The data 416 can include check information, customer identification information, clerk identification information, a verification code, time data and date data. In the FIG. 4 embodiment of the present invention, the software 418 includes verification application 420B and settlement application 420A physically connected to one another. In an embodiment of the present invention, verification application 420B and settlement application 420A can be provided on separate systems. The software 418 provides the functionality for receiving check transaction information, verification response, disbursement requests, processing the transaction information, verification responses and disbursement requests, transmitting verification request, funds disbursement notification and settlement notifications.

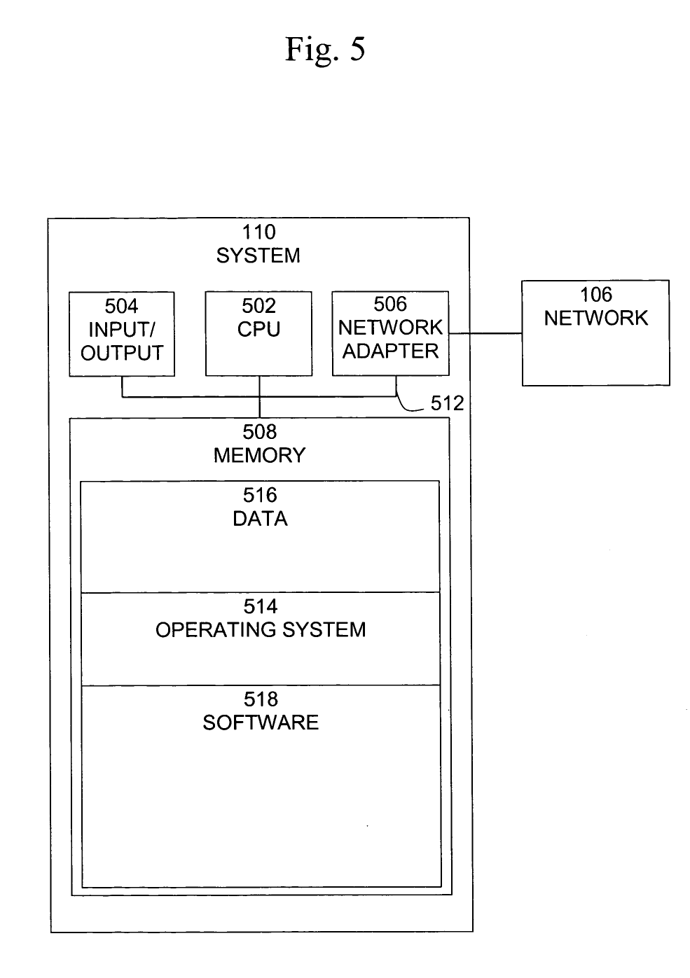

An exemplary block diagram of a system 110 of FIG. 1 which can find application according to an embodiment of the present invention is shown in FIG. 5. In the FIG. 5 embodiment of the present invention, the system 110 includes input/output device interface 504, network adapter 506, system memory 508 and CPU 502. The CPU 502 is connected by a bus 512 or other suitable interface means to system memory 508, input/output device interface 504, and network adapter 506. The CPU 502 executes program instructions in order to carry out the functions of the present invention.

Input/output device interface 504 provides the capability to input data to, or output data from system 110. For example, input/output device interface 504 includes, but is not limited to, input devices such as a readers, keyboards, mice, touchpads, trackballs, etc., output devices such as video, monitors, printers, etc., and input/output devices such as dialer/modems, etc. Input/output device interface 504 enables receipt of verification requests and settlement notifications as well as transmission of verification responses. Network adapter 506 interfaces system 110 with network 106.

System memory 508 stores program instructions that are executed by, and data that are used and processed by, CPU 502 to perform the functions of system 110. System memory 508 can include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which can use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the FIG. 5 embodiment of the present invention, system memory 508 includes operating system 514, data 516 and software 518. Operating system 514 provides overall system functionality. The data 516 can include information related to issued checks, settlement files, and check status information. The software 518 provides the functionality for receiving verification requests and settlement notifications, processing verification requests, including but not limited to, flagging information associated with a check as verified, transmitting verification responses, and creating settlement files.

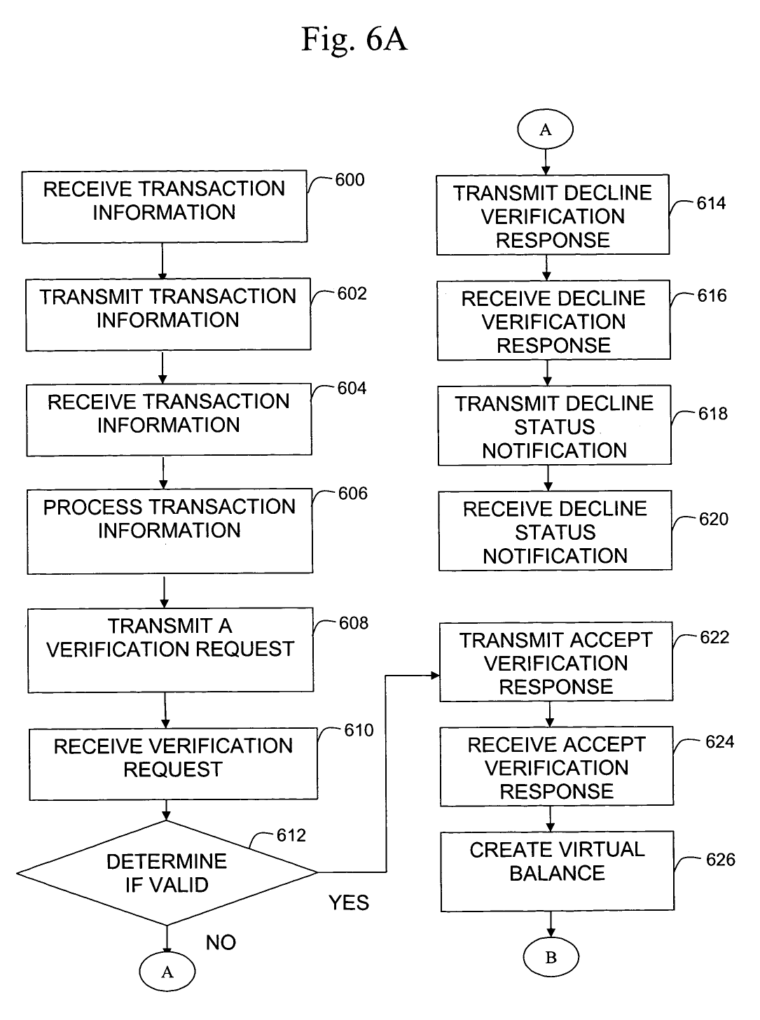

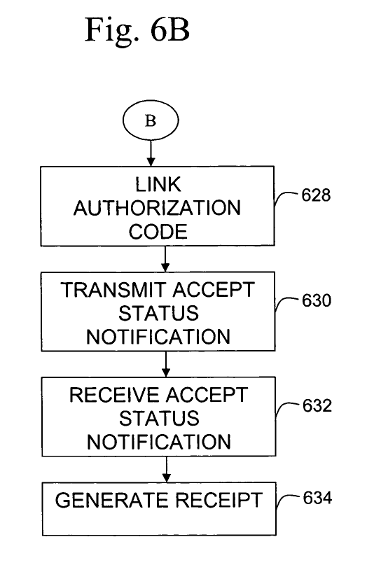

An exemplary flow diagram for a method of providing an interface for check cashing verification according to an embodiment of the present invention is shown in FIGS. 6A-6B. In the FIGS. 6A-6B embodiment, the process begins with step 600. In step 600, check cashing transaction information is received by system 102. In the FIG. 6A embodiment of the present invention, system 102 is located at the site offering real time negotiation of checks. The check cashing transaction information includes, but is not limited to, a clerk Personal Identification Number (PIN) check information, and customer identification information. The customer identification information can include a PIN number selected by the customer and the customer's Social Security number. The check cashing transaction information can include a dollar value and a check authorization number of an issued check desired to be negotiated for monies as well as an account number and a routing number for the financial institution that issued the check.

At step 602, the check cashing transaction information is transmitted from system 102 to system 109. Acceptance of a fee may be required prior to the transmission of the check cashing transaction information to system 109 to cover the cost of providing the service. The check cashing transaction information is transmitted over the network 106.

At step 604, the check cashing transaction information is received by system 109 from system 102. At step 606, the check cashing transaction information is processed by system 109. At step 608, a verification request is transmitted to a system 110 of systems 110 from the system 109. The system 110 is the system of the financial institution that allegedly issued the check being negotiated for monies. The verification request can be provided as a Universal Resource Locator (URL) applicable with an Active Server Page (ASP) model. System 109 and system 110 are directly linked through network 106.

At step 610, the system 110 receives the verification request. At step 612, the system 110 determines whether a segment of the transaction information is valid. The segment of transaction information includes, but is not limited to, a dollar value, a check number and a check authorization number. Determining whether a segment of the transaction information is valid includes, but is not limited to comparing the segment of transaction information with issued check information stored in the system 110. If the segment of transaction information is determined to be invalid, then the process proceeds to step 614.

At step 614, a decline verification response is transmitted to the system 109 from the system 110. The decline verification response can be provided as an XML transaction message. The types of decline verification responses include, but are not limited to, successful request, authorization number not found, dollar mismatch, name mismatch, invalid transaction, already settled, and try again later host unavailable.

At step 616, the decline verification response is received by system 108 from system 110. At step 618, a decline status notification information is transmitted from the system 109 to the system 102. At step 620 , the decline status notification is received by system 102 from system 109. The decline status notification indicates that the check has not been verified and thus not negotiable using a system, such as an ATM. The check is then returned to the customer. If the segment of transaction information is determined to be valid, then the process proceeds to step 622.

At step 622, an accept verification response is transmitted to the system 109 from the system 110. The accept verification response can be provided as an XML transaction message. The types of decline verification responses include, but are not limited to, authorization number not found, dollar mismatch, name mismatch, invalid transaction, already settled, and try again later host unavailable.

At step 624, the accept verification response is received by system 109 from system 110. At step 626, a virtual balance is created. At step 628, a check authorization code is linked to the virtual balance. At step 630, accept status notification information is transmitted from the system 109 to the system 102. The accept status notification indicates that the check has been verified, and thus, negotiable using a system, such as an ATM. At step 632, the accept status notification is received by system 102 from system 109. At step 634, a receipt is generated by system 102 including the check authorization code.

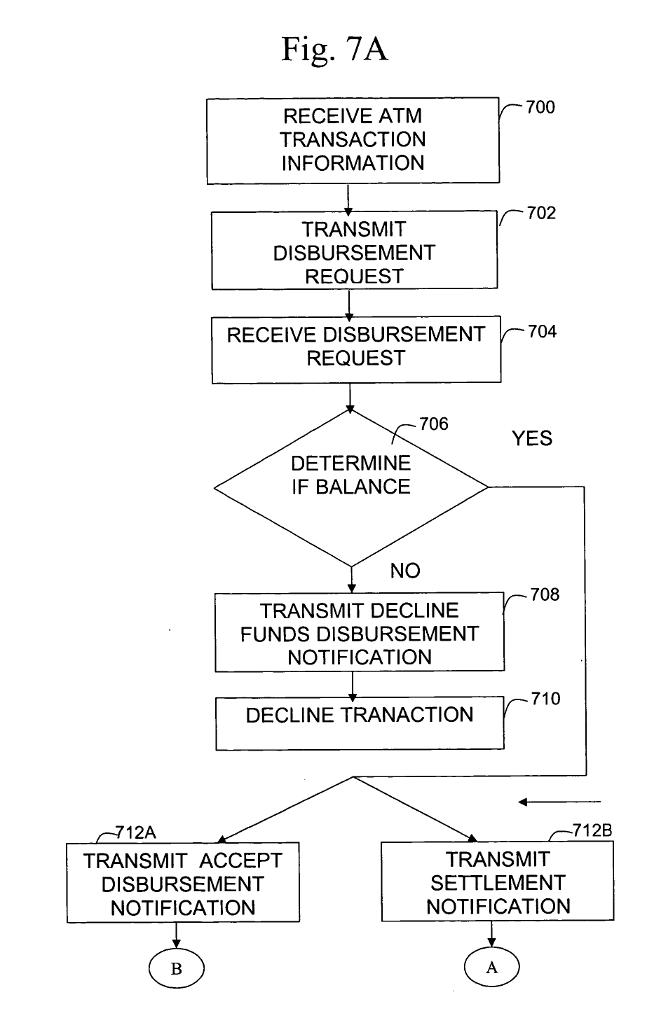

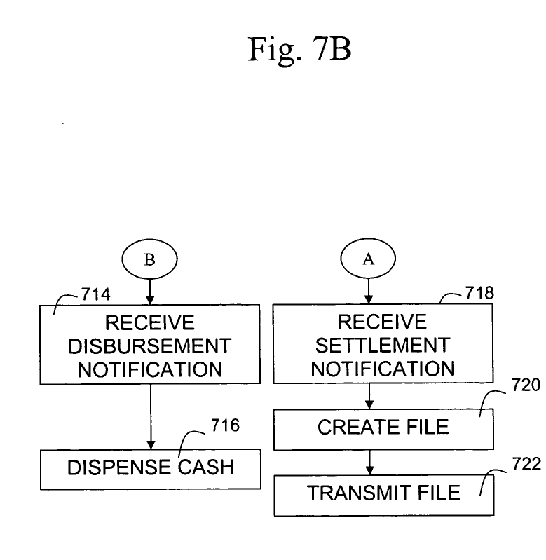

An exemplary flow diagram for a method of providing an interface for electronic settlement of check cashing transaction according to an embodiment of the present invention is shown in FIGS. 7A-7B. In the FIGS. 7A-7B embodiment, the process begins with step 700. At step 700, ATM transaction information is receive by system 104. the ATM transaction information includes, but is not limited to, a check authorization code and customer identification information is received by a system 104. The system 104 can be one that is paired with the system 102. At step 702, a disbursement request is transmitted to system 109 from system 104. The disbursement request includes, but is not limited to, the check authorization code and customer identification information.

At step 704, the disbursement request is received by the system 109 from the system 104. At step 706, the disbursement request is processed by the system 109. Processing the disbursement request includes, but is not limited to, determining whether there is a balance available to execute the request. If a balance is determined to be available the process proceeds to step 712A and 712B.

If a balance is determined not to be available then the process proceeds to step 708. At step 708, a decline notification is transmitted from the system 109 to the system 104. The decline notification indicates that a balance is not available. At step 710, the cash disbursement transaction is declined.

At step 712B, a settlement notification is sent from system 109 to system 110. The settlement notification indicates that cash has been dispensed from the virtual account to which a check is linked. At step 718, the notification is received by system 110 from system 109. The transaction settlement notification includes, but is not limited to, the routing number and account number associated with the entity that has provided the cash. At step 720, a settlement file is created for the transaction by system 110. At step 722, the settlement file is transmitted by system 110 to an entity, such as the Federal Reserve or Vault Cash Provider.

At step 712A, a funds disbursement notification is transmitted from the system 109 to the system 104. The funds disbursement notification indicates that a balance is available in the virtual account to which the check authorization code is linked. At step 714, the disbursement notification is received by system 104 from system 109. At step 716, system 104 disburses the cash to the customer.

While specific embodiments of the present invention have been illustrated and described, it will be understood by those having ordinary skill in the art that changes can be made to those embodiments without departing from the spirit and scope of the invention.

What is claimed is:

1. A method of providing an interface for check cashing verification, the method comprising the steps of:
providing transaction information;
receiving a verification request including, at least, the transaction information;
determining whether the verification request includes valid transaction information;
providing a type of verification response based on the determination of whether the verification request includes valid transaction information; and
generating a check cashing authorization code based on the type of verification response.

2. The method according to claim 1, further comprising providing a decline type of verification response upon a determination that the verification request includes invalid transaction information.

3. The method according to claim 2, further comprising providing a decline status notification.

4. The method according to claim 4, further comprising creating a virtual account.

5. The method according to claim 5, further comprising providing an accept status notification.

6. The method according to claim 1, further comprising generating a receipt including the check cashing authorization code.

7. The method according to claim 1, further comprising providing the check cashing authorization code.

8. The method according to claim 1, further comprising dispensing cash in response to the check cashing authorization code.

9. The method according to claim 1, further comprising providing a decline type of verification response upon a determination that the verification request includes invalid transaction information.

10. A method of providing an interface for electronic settlement of a check cashing transaction, the method comprising the steps of:
providing transaction information including, at least, a check cashing authorization code.
receiving settlement notification; and
creating a settlement file in accordance with settlement notification.
dispensing cash based on the transaction information.

11. The method according to claim 10, further comprising transmitting the settlement file.

12. A system for providing check verification, and check cashing comprising:
a first system operable to provide transaction information;
a network;
a second system, coupled to the network and the first system, operable to:
receive a verification request including, at least, the transaction information;
determine whether the verification request includes valid transaction information; and
provide a type of verification response based on the determination of whether the verification request includes valid transaction information; and
the first system operable to generate a check cashing authorization code based on the type of verification response.

13. The system according to claim 12, further comprising the second system operable to provide a decline type of verification response upon a determination that the verification request includes invalid transaction information.

14. The system according to claim 13, further comprising the second system operable to provide a decline status notification.

15. The system according to claim 12, further comprising the second system operable to provide an accept type of verification response upon a determination that the verification request includes valid transaction information.

16. The system according to claim 15, further comprising the first system operable to create a virtual account.

17. The system according to claim 16, further comprising the second system operable to provide an accept status notification.

18. The system according to claim 12, further comprising a third system, coupled to the network, the first system and second system, operable to generate a receipt including the check cashing authorization code.

19. The system according to claim 12, further comprising the first system operable to provide the check cashing authorization code.

20. The system according to claim 12, further comprising a fourth system, coupled to the network, the first system the second system and the third system, operable to dispense monies in response to the check cashing authorization code.

21. A system for providing check settlement of a check cashing transaction, the comprising:
a first system operable to:
provide transaction information including, at least, a check cashing authorization code; and
dispense cash based on the transaction information;
a network; and
a second system, coupled to the network and the first system, operable to:
receive a settlement notification; and
create a settlement file in accordance with settlement notification.

22. The system according to claim 21, further comprising the second system operable transmit the settlement file to a remote locating.

23. A computer program product for providing an interface for check cashing verification, comprising:
a computer readable medium; and
computer program instructions, recorded on the computer readable medium, executable by a processor, for performing the steps of:
providing transaction information;
receiving a verification request including, at least, the transaction information;
determining whether the verification request includes valid transaction information;
providing a type of verification response based on the determination of whether the verification request includes valid transaction information; and
generating a check cashing authorization code based on the type of verification response.

24. The computer program product according to claim 23, further comprising computer program instruction for performing the step of providing a decline type of verification response upon a determination that the verification request includes invalid transaction information.

25. The computer program product according to claim 24, further comprising computer program instructions for performing the step of providing a decline status notification.

26. The computer program product according to claim 25, further comprising computer program instructions for performing the step of creating a virtual account.

27. The computer program product according to claim 26, further comprising providing computer program instructions for performing the step of providing an accept status notification.

28. The computer program product according to claim 23, further comprising computer program instruction for performing the step of generating a receipt including the check cashing authorization code.

29. The computer program product according to claim 23, further comprising computer program instruction for performing the step of providing the check cashing authorization code.

30. The computer program product according to claim 23, further comprising computer program instruction for performing the step of dispensing cash in response to the check cashing authorization code.

31. The computer program product according to claim 23, further comprising computer program instructions for performing the step of providing a decline type of verification response upon a determination that the verification request includes invalid transaction information.

32. A computer program product for providing an interface for electronic settlement of a check cashing transaction, comprising:
a computer readable medium; and
computer program instructions, recorded on the computer readable medium, executable by a processor, for performing the steps of:
providing transaction information including, at least, a check cashing authorization code;
receiving settlement notification; and
creating a settlement file in accordance with settlement notification. dispensing cash based on the transaction information.

33. The computer program product according to claim 32, further comprising computer program instructions for performing the step of transmitting the settlement file.
